(19) United States
(12) Patent Application Publication
(10) Pub. No.: US 2009/0050004 A1
(43) Pub. Date: Feb. 26, 2009

(54) METHOD FOR OPERATING A ROTARY PRINTING PRESS

(75) Inventor: Wolfgang HIESINGER, Biberbach (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/195,026

(22) Filed: Aug. 20, 2008

(30) Foreign Application Priority Data
Aug. 21, 2007 (DE) 10 2007 039 485.5

(51) Int. Cl. B41F 5/04

(52) U.S. Cl. 101/219

(57) ABSTRACT

A method for operating a rotary printing press is disclosed. The printing press having multiple printing units for printing at least one substrate web, a folder superstructure downstream from the printing units, having at least one former for lengthwise folding of the/each substrate web and/or partial webs of the/each substrate web, and having a folder downstream from the folder superstructure for separating copies and for forming at least one lengthwise fold and/or cross fold on the separated copies. Modules of the folder superstructure serving at least to process the/each substrate web and/or partial web are essentially adapted to the increase in width which occurs in printing of the/each substrate web.

This application claims the priority of German Patent Document No. 10 2007 039 485.5, filed Aug. 21, 2007, the disclosure of which is expressly incorporated by reference herein.

### BACKGROUND AND SUMMARY OF THE INVENTION

The invention relates to a method for operating a rotary printing press.

In a rotary printing press, at least one substrate web is printed in multiple printing units. After printing, the/each substrate web is usually supplied to a turner bar nest downstream from the printing units, the/each substrate web being separated into partial webs in the area of the turner bar nest and/or the/each substrate web and/or partial webs being optionally turned. A folder superstructure having at least one former for lengthwise folding of the/each substrate web and/or the partial webs is arranged downstream from the turner bar nest and thus the printing units. A folder is arranged downstream from the folder superstructure, copies being separated from the/each substrate web and/or from the partial webs by cross cutting in the area of the folder. At least one lengthwise fold and/or at least one cross fold is/are formed on the copies in the areas of the folder.

The modules of the turner bar nest and/or folder superstructure that serve to process the/each substrate web and/or partial web are typically adapted to a fixed format of substrate web and/or partial web. In the past, it has not been possible to compensate for tolerances in the width of a substrate web that occur in printing.

Against this background, the problem on which the present invention is based is to create a novel method for operating a rotary printing press.

According to the invention, modules of the folder superstructure that serve at least to process the/each substrate web and/or partial web are adapted to an increase in width of the/each substrate web, which develops during printing.

In the sense of the present invention, it is provided for the first time that an increase in width of the/each substrate web which develops during the printing of the/each substrate web may be compensated by the fact that at least the modules of the folder superstructure and optionally the turner bar nest that serve to process the/each substrate web and/or partial web are adapted. It is possible in this way to compensate for an increase in width of the substrate web caused by introduction of moisture into the printed substrate web, thereby improving the quality of products produced on the rotary printing press.

Preferred further embodiments of the invention are derived from the following description. Although the invention is not limited to these embodiments, exemplary embodiments of the invention are explained in greater detail below with reference to the drawing.

### BRIEF DESCRIPTION OF THE DRAWING

FIG. 1 shows a schematic diagram to illustrate the inventive method for operating a rotary printing press.

### DETAILED DESCRIPTION OF THE DRAWING

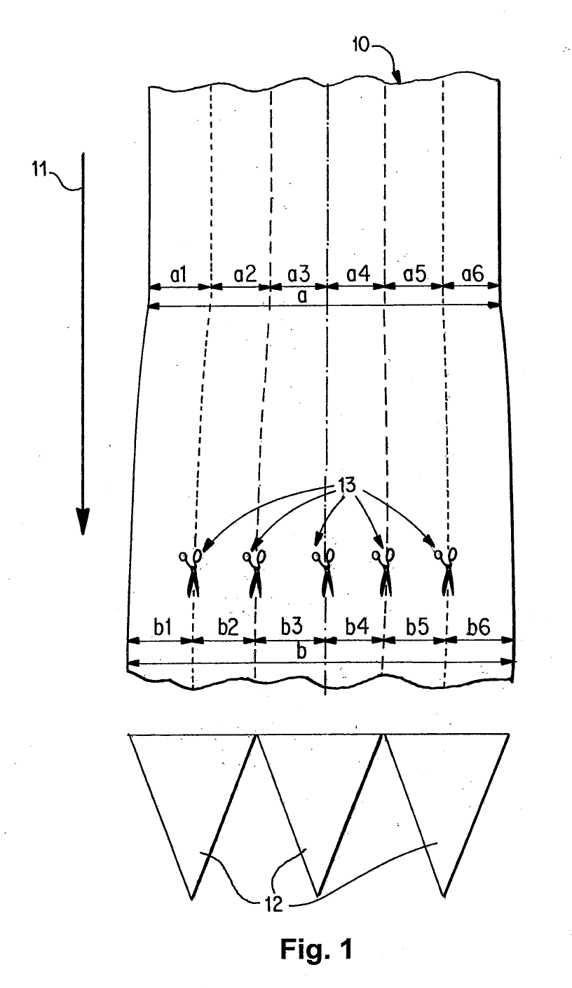

The present invention relates to a method for operating a rotary printing press, whereby the inventive method is described below with reference to FIG. 1 for a preferred exemplary embodiment.

FIG. 1 shows in highly schematized form a substrate web 10 printed in a rotary printing press and conveyed through the rotary printing press in the direction of the arrow 11.

It shall be assumed below that the substrate web, which has not yet been printed and therefore is yet to be printed, has width a before being printed and has width b after being printed, such that width b after printing is greater than width a before printing, this increase in width of substrate web 10 due to printing being dependent on the type of substrate used on the one hand and being dependent on the amount of dampening solution used for printing on the other hand.

The substrate web 10 shown in FIG. 1 is a six-page-wide substrate web, where the sides have the width a1, a2, a3, a4, a5 and/or a6 before being printed and have the width b1, b2, b3, b4, b5 and/or b6 after printing.

The printed substrate web 10 is supplied to formers 12 of a folder superstructure in the direction of the arrow 11, where the substrate web 10 is separated into either three partial webs or six partial webs by cutting lengthwise with the help of the cutting devices 13 upstream from the formers 12. The partial webs are then supplied to the formers 12.

In the case of the rotary printing presses known in practice, the formers 12 of the folder superstructure, as well as the cutting devices 13 upstream from the formers 12, are designed based on the width a of the substrate web 10 before printing the same. In the sense of the present invention, it is provided that a rotary printing press shall be operated in such a way that at least the modules of the folder superstructure which serve to process the printed substrate web and/or the partial web are adapted to an increased width of the substrate web 10, which develops during printing.

In the exemplary embodiment shown here, at least the two outer formers 12 and the outer cutting devices 13 are displaced across the direction of conveyance (arrow 11) of the substrate web 10. In the case of printing presses which have a turner bar nest upstream from the folder superstructure, lengthwise cutting devices and turner bars assigned to the turner bar nest may be adapted to the increase in width of the printed substrate web. In addition, nipper rollers and/or other web guide rollers of the folder superstructure and optionally the turner bar nest may be adapted to the increase in width of the printed substrate web.

Typically, the central position of the substrate web 10 relative to the printing press does not change as a result of the increase in width of same, so in the exemplary embodiment shown here, the central former 12 and the central lengthwise cutting device 13, each of which is aligned with the center of the substrate web 10, remain unchanged in their position.

As already explained, the increase in width of the substrate web depends on the type of substrate and the amount of dampening solution used for printing. Displacement of the respective former 12 and lengthwise cutting devices 13 to compensate for the growth in width of the printed substrate web 10 preferably takes place on the basis of values determined empirically in advance, depending on the type of substrate and the amount of dampening solution.

With the types of paper used for newsprint, the increase in growth of the printed substrate web amounts to between 1 per mill and 3 per mill; it follows from this that the formers 12 and the lengthwise cutting devices 13 are also shifted in this order of magnitude to compensate for the increase in width.

### LIST OF REFERENCE NUMERALS

10 Substrate web

11 Direction of conveyance

12 Former

13 Cutting device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a rotary printing press, having multiple printing units for printing at least one substrate web, a folder superstructure downstream from the printing units and having at least one former for lengthwise folding of the/each substrate web and/or a partial web of the/each substrate web, and a folder downstream from the folder superstructure for separating copies and for forming at least one lengthwise fold and/or cross fold on the copies separated, wherein at least modules of the folder superstructure serving to process the/each substrate web and/or the partial web are adapted to an increase in width that develops in printing between the/each substrate web.

2. The method according to claim 1, wherein modules of a turner bar nest downstream from the printing units and upstream from the folder superstructure are adapted to an increase in width of the/each substrate web that develops during printing, the turner bar nest serving to separate the/each substrate web into partial webs and/or to turn the/each substrate web and/or partial web.

3. The method according to claim 1, wherein the at least one former of the folder superstructure is displaced across a direction of conveyance of the/each substrate web.

4. The method according to claim 1, wherein cutting devices of the folder superstructure and/or a turner bar nest are shifted across a direction of conveyance of the/each substrate web.

5. The method according to claim 1, wherein nipper rollers of the folder superstructure and/or a turner bar nest are adapted to the increase in width.

6. The method according to claim 1, wherein the adaptation of the modules of the folder superstructure and/or a turner bar nest is performed as a function of a type of substrate of the/each substrate web.

7. The method according to claim 1, wherein the adaptation of the modules of the folder superstructure and/or a turner bar nest is made as a function of an amount of dampening solution used for printing.

8. A method for operating a rotary printing press, comprising the steps of:
printing a substrate web in a printing unit; and
moving a module of a folder superstructure downstream from the printing unit based on an increase in a width of the substrate web.

9. The method according to claim 8, wherein the module is a former.

10. The method according to claim 9, wherein the former is disposed offset from a center of the printed substrate web.

11. The method according to claim 8, wherein the module is a cutting device.

12. The method according to claim 11, wherein the cutting device is disposed offset from a center of the printed substrate web.

13. The method according to claim 8, wherein the module is moved in a direction that is perpendicular to a direction of conveyance of the substrate web.

14. The method according to claim 8, wherein a distance that the module is moved is empirically determined prior to the printing of the substrate web.

15. The method according to claim 8, wherein the step of moving the module of the folder superstructure is in response to the increase in the width of the substrate web after printing in the printing unit.

16. The method according to claim 8, wherein a distance that the module is moved is based on a type of the substrate web.

17. The method according to claim 8, wherein a distance that the module is moved is based on an amount of dampening solution applied to the substrate web during the printing step.
